(19) United States
(12) Patent Application Publication
(10) Pub. No.: US 2023/0389532 A1
(43) Pub. Date: Dec. 7, 2023

(54) LIGHT-EMITTING DIODE FITTED INSECT TRAPPING DEVICE

(71) Applicant: AMERICAN INSECT ATTRACTANTS LLC, Jamestown, RI (US)

(72) Inventors: Sam LIU, Pleasant Hill, CA (US); Raymond W. IANNETTA, Jamestown, RI (US); Miao YONG CAO, Warwick, RI (US)

(21) Appl. No.: 18/249,025

(22) PCT Filed: Oct. 14, 2021
(86) PCT No.: PCT/US2021/054937

§ 371 Date: Apr. 13, 2023

Related U.S. Application Data
(60) Provisional application No. 63/092,044, filed on Oct. 15, 2020.
(60) Provisional application No. 63/154,330, filed on Feb. 26, 2021.

(51) Int. Cl. A01M 1/02; A01M 1/08; A01M 1/10

(52) U.S. Cl. CPC A01M 1/023; A01M 1/08; A01M 1/106

(57) ABSTRACT

An insect trapping apparatus includes a source of carbon dioxide for emission into the atmosphere, a chamber housing a catalyst to ignite the source of carbon, a cartridge containing a chemical attractant, the emission containing the chemical attractant, a trap for holding captured insects, and a vacuum capable of drawing the insects into the trap through a collar, the collar including a light-emitting diode (LED) fixture.

### CROSS REFERENCE TO RELATED APPLICATIONS

This application claims benefit from U.S. Provisional Patent Application Ser. No. 63/092,044, filed Oct. 15, 2020, and U.S. Provisional Patent Application Ser. No. 63/154,330, filed Feb. 26, 2021, each of which is incorporated by reference in its entirety.

### STATEMENT REGARDING GOVERNMENT INTEREST

None.

### BACKGROUND OF THE INVENTION

The present invention relates generally to devices and methods for controlling mosquitoes and other biting insects, and more particularly to a light-emitting diode (LED) fitted insect trap device.

Insect traps, such as mosquito traps, of many different designs exist in the marketplace. For example, propane mosquito traps are designed to take advantage of the signals mosquitoes use to find humans. Mosquitoes are attracted to body heat and the carbon dioxide and water vapor humans exhale. Propane mosquito traps, for example, produce all of these things, sometimes together with additional lure products like octenol (produced by cows). Thus, they mimic a living, breathing mammalian target. In order to produce these human signals, these mosquito traps use propane and have a catalytic converter that transforms the propane into carbon dioxide.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features an insect trapping apparatus including a source of carbon dioxide for emission into the atmosphere, a chamber housing a catalyst to ignite the source of carbon, a cartridge containing a chemical attractant, the emission containing the chemical attractant, a trap for holding captured insects, and a vacuum capable of drawing the insects into the trap through a collar, the collar including a light-emitting diode (LED) fixture.

In another aspect, the invention features an insect trapping apparatus including a source of carbon dioxide for emission into the atmosphere, a chamber housing a catalyst to ignite the source of carbon, a chemical lure housing, a cartridge containing a chemical attractant, the emission containing the chemical attractant, a trap for holding captured insects, and a vacuum capable of drawing the insects into the trap through a collar, the collar including a light-emitting diode (LED) fixture.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 illustrates an exemplary insect trapping device.

FIG. 2 illustrates an exemplary insect trapping device having a LED fixture.

FIG. 3 illustrates an exemplary LED fixture.

FIG. 4 illustrates an exemplary circuit diagram of a LED fixture.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used herein, the different phrases will have the meanings as described in this and other sections of the application.

The term “insect attracting system” as used herein represents a combination of multiple components including individual chemical entities, mixture of two or more chemical entities, physical embodiment including a container, trapping devices To enable trapping insects including mosquitoes, and other components known to one skilled in the art to help practice the instant invention.

The term “at least” is used to indicate that a given embodiment includes at least the number of components indicated. It is understood that a given embodiment can include more than the at least number of components indicated. The term at least is to be construed to define the lower limit of components and not the upper limit of components.

The “housing” as used herein represents a physical container which can hold and or accommodate at least some of the components of the instant invention a typical housing will have multiple independent zones and/door compartments separated by a partition such that each zone/compartment respectively holds, for example, the saturated, partially unsaturated, or an aromatic alcohol, lactic acid, and a metallic or nonmetallic base. A typical housing will also include a lid or cover to encase the multiple independent zones or compartments. The housing can be made from different materials such as plastic, wood, metal, or combinations thereof. The housing material typically would not interact/react with the materials that it holds or accommodates.

The term “insect” as used herein is intended to represent flying pests, including mosquitoes. The term insect includes both genders, male and female.

Cows naturally attract insects, particularly mosquitoes. One way to eliminate mosquitoes is to acquire a cow. Since acquiring a cow is not an option for most people, one can eliminate mosquitoes by using an artificial cow. This is what a propane mosquito trap attempts to do. To succeed, a propane mosquito trap needs to include a way to produce carbon dioxide, a way to create warmth and moisture and a way to produce the plant chemicals that cows produce.

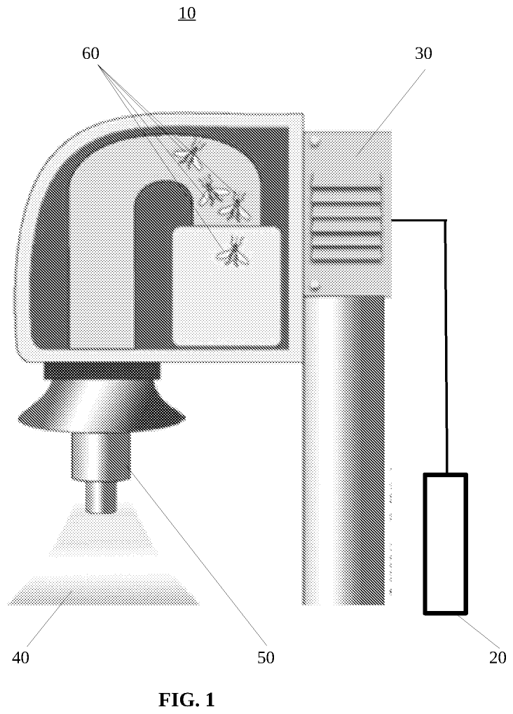

FIG. 1 illustrates an exemplary insect trapping device 10 that combines these three things with an automatic vacuuming system. Here, the insect trapping device 10 includes a propane tank 20 that provides a source of propane to a chamber 30. Propane is a gas that contains carbon and hydrogen, so when it is burned it produces carbon dioxide and water vapor. Here, the propane is burned catalytically in the chamber 30, using the same idea as used in an automotive catalytic converter.

The propane comes into the chamber 30 and hits the catalyst, e.g., a set of ceramic beads or a ceramic grid coated with platinum. The catalyst converts the propane directly to combination of heat, carbon dioxide and moisture without actually needing a flame.

Carbon dioxide is not enough. To complete a chemical signature of a cow a cartridge 50 is included that contains, for example, 1-Octen-3-ol (“octenol”) or Lurex®, a proprietary mixture that simulates sweat chemicals. These chemicals act as strong attractants for different types of mosquitoes.

By mixing the chemical attractant with the carbon dioxide and moisture and then blowing it out into the surrounding air, the insect trapping device 10 creates a plume 40 of gas that mosquitoes find irresistible. They will fly upwind to follow the plume 40 to its source.

When the mosquitoes get to the insect trapping device 10, they encounter a vacuum created by a fan (not shown), just like a vacuum cleaner. The fan sucks in air and the mosquitoes 60. The mosquitoes 60 are trapped in a net bag 70, where they dehydrate and die.

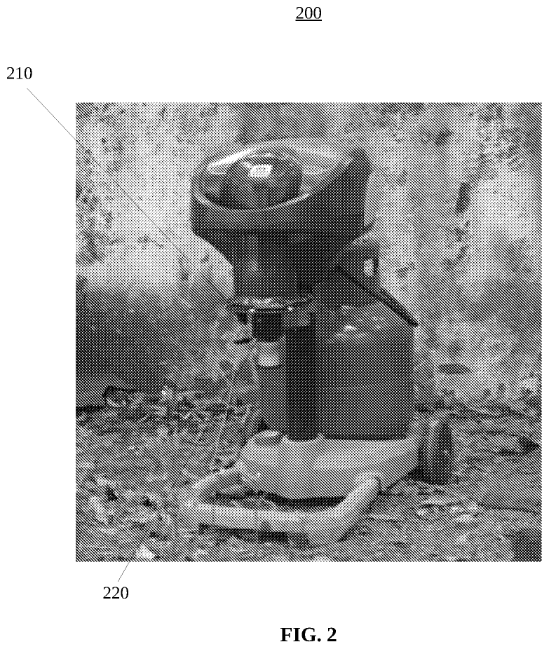

As shown in FIG. 2, an exemplary insect trapping device 200 includes the components described above with respect to FIG. 1 and an addition of an exemplary light-emitting diode (LED) fixture 210. More specifically, the LED fixture 210 is fitted and secured around a suction tube 220.

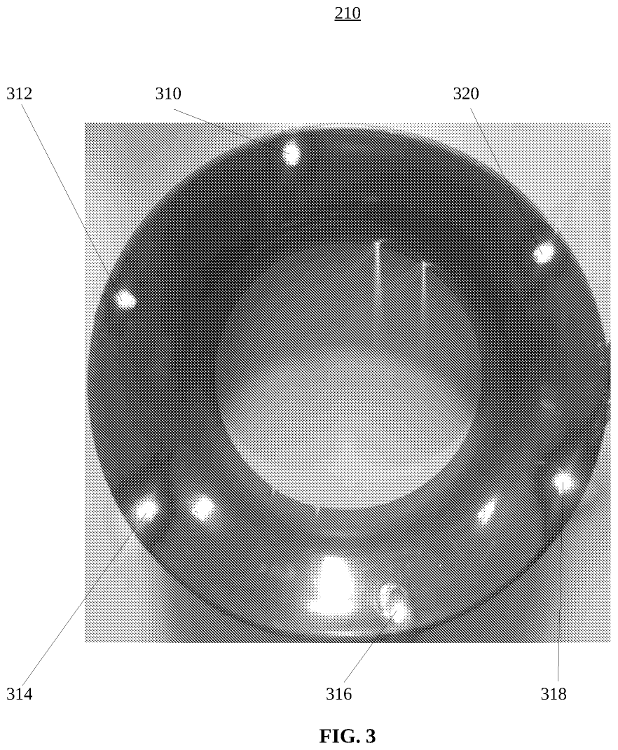

As shown in FIG. 3, the light-emitting diode (LED) fixture 210, in one embodiment, includes six LED light positive/negative solder points 310, 312, 314, 316, 318, 320. Insects of all type, including mosquitoes, are attracted to both the light and the plume.

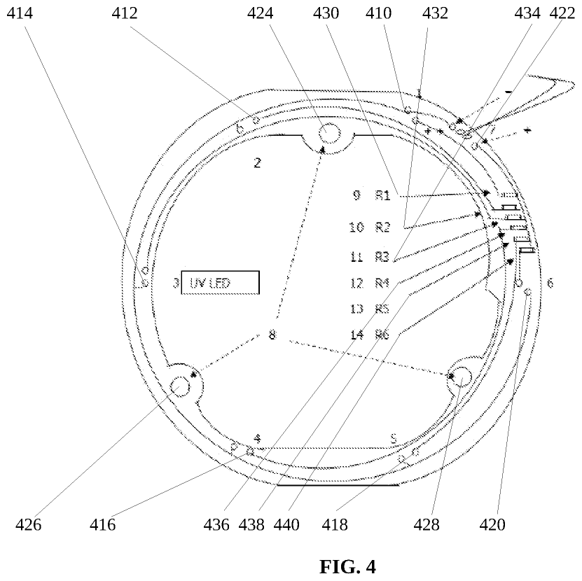

In FIG. 4, an exemplary circuit diagram 400 of the light-emitting diode (LED) fixture 210 is FIG. 2 and FIG. 3 is illustrated. The circuit diagram 400 includes six LED light positive/negative solder points 410, 412, 414, 416, 418, 420 and a power connection point 422. In addition, there are three holes 424, 426, 428 to secure the light-emitting diode (LED) fixture 210 to a suction section of an insect trapping device. Resistors 430, 432, 434, 436, 438, 440 are connected to respective LED light positive/negative solder points.

The LED fixture 210 can increase a mosquito catching rate two fold and more compared to prior insect trapping devices because mosquitoes (not shown) are attracted to the combined plume and LED light. In preferred embodiments, the LED fixture 210 is a UV LED emitting wavelengths from 365 nanometer (nm) to 390 nm.

In another embodiment, the system described above includes a first chemical lure, such as lactic acid, a salt of lactic acid, or combinations thereof, and a second chemical lure, the second lure including a source of ammonia. The first and second chemical lures may be employed in particular geometric shapes contained in a specifically designed housing to ensure an effective release rate over extended periods of time. The resulting system exhibits a good synergy between LED lighting and chemical lures in attracting mosquitoes, while an efficacy of insect trapping increases substantially.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. An insect trapping apparatus comprising:
a source of carbon dioxide for emission into the atmosphere;
a chamber housing a catalyst to ignite the source of carbon;
a cartridge containing a chemical attractant, the emission containing the chemical attractant;
a trap for holding captured insects; and
a vacuum capable of drawing the insects into the trap through a collar, the collar including a light-emitting diode (LED) fixture.

2. The insect trapping apparatus of claim 1 wherein the LED fixture comprises:
LED light positive/negative solder points;
a power connection point;
holes to secure the light-emitting diode (LED) fixture to the collar; and
resistors connected to respective LED light positive/negative solder points.

3. The insect trapping apparatus of claim 2 wherein the source of carbon dioxide is propane.

4. The insect trapping apparatus of claim 3 wherein the chemical attractant is 1-Octen-3-ol.

5. The insect trapping apparatus of claim 1 further comprising:
a first chemical lure; and
a second chemical lure.

6. The insect trapping apparatus of claim 5 wherein the first chemical lure is lactic acid.

7. The insect trapping apparatus of claim 5 wherein the first chemical lure is a salt of lactic acid.

8. The insect trapping apparatus of claim 5 wherein the second chemical lure is a source of ammonia.

9. The insect trapping apparatus of claim 5 wherein the first and second chemical lures are employed in particular geometric shapes contained in a lure housing to ensure an effective release rate over extended periods of time.

10. The insect trapping apparatus of claim 5 wherein the light-emitting diode (LED) fixture emits UV light.

11. The insect trapping apparatus of claim 5 wherein the UV light has a wavelength of 365 nm.

12. The insect trapping apparatus of claim 5 wherein the UV light has a wavelength of 390 nm.

13. An insect trapping apparatus comprising:
a source of carbon dioxide for emission into the atmosphere;
a chamber housing a catalyst to ignite the source of carbon;
a chemical lure housing;
a cartridge containing a chemical attractant, the emission containing the chemical attractant;
a trap for holding captured insects; and
a vacuum capable of drawing the insects into the trap through a collar, the collar including a light-emitting diode (LED) fixture.

14. The insect trapping apparatus of claim 13 wherein the chemical lure housing includes a first chemical lure and a second chemical lure.

15. The insect trapping apparatus of claim 14 wherein the first chemical lure is lactic acid.

16. The insect trapping apparatus of claim 14 wherein the first chemical lure is a salt of lactic acid.

17. The insect trapping apparatus of claim 14 wherein the second chemical lure is a source of ammonia.
